(19) United States
(12) Patent Application Publication
(10) Pub. No.: US 2005/0183638 A1
(43) Pub. Date: Aug. 25, 2005

(54) Snap on table for torchiere lamps and other supports

(76) Inventor: Austin S. Lin, Cambridge, MA (US)

Correspondence Address: ELMORE,CRAIG & VANSTONE, P.C., 209 MAIN STREET, N. CHELMSFORD, MA, 01863, US

(21) Appl. No.: 10/886,930

(22) Filed: Jul. 8, 2004

Related U.S. Application Data
(60) Provisional application No. 60/546,536, filed on Feb. 21, 2004.

(51) Int. Cl. B65D 19/00; B65G 35/00

(52) U.S. Cl. 108/51.11

(57) ABSTRACT

The invention relates to a table surface for attachment to a support, such as a rigid or semi-rigid support, characterized by an aperture which receives the support and which is substantially, preferably solely, supported by friction between the sides of the aperture and the support. The invention has the advantage of being easy to manufacture, aesthetically pleasing, and highly versatile. The invention relates to the table surface, its methods of use, including a means or method of joining a table surface to a torchiere lamp and a means or method of installing the table surface without the need for clamping hardware or tools, and its methods of manufacture.

### RELATED APPLICATION

This application claims the benefit of U.S. Provisional Application No. 60/546,536 filed on Feb. 21, 2004. The entire teachings of the above application are incorporated herein by reference.

### BACKGROUND OF THE INVENTION

Standing lamps with built-in tables are common as are standing or torchiere lamps. Removable surfaces, such as tables and shelves, for standing lamps and other supports have been previously described, however, these devices are not self-supporting. For example, U.S. Design Pat. 291,635 describes a tray for attachment to a beach umbrella. The tray is entirely supported by a threaded collar (FIG. 1) and two screws which tighten the collar to the umbrella pole. See FIGS. 2 and 3. U.S. Pat. No. 4,383,487 describes a removable tray for attachment to a microphone that clamps to the microphone. The tray is taught to support such lightweight materials as cigarettes, matches, lighters, drinks and sheet music. U.S. Pat. No. 6,347,591 describes a table suitable for use with a torchiere. However, the table is supported by legs. Thus, a need exists for a new and improved device for providing a stable table surface that may be joined to a standing lamp or other similar support which is substantially self-supporting and easy to use.

### SUMMARY OF THE INVENTION

The invention relates to a table surface for attachment to a support, such as a rigid or semi-rigid support, characterized by an aperture which receives the support and which is substantially, preferably solely, supported by friction between the sides of the aperture and the support. The invention has the advantage of being easy to manufacture, aesthetically pleasing, and highly versatile. The invention relates to the table surface, its methods of use, including a means or method of joining a table surface to a torchiere lamp and a means or method of installing the table surface without the need for clamping hardware or tools, and its methods of manufacture.

In a preferred embodiment, the invention relates to a table surface for attachment to a rigid support characterized by an aperture which receives the rigid support, wherein said table surface consists of two interlocking pieces manufactured of rigid deformable foam and is solely supported by friction between the sides of the aperture and the rigid support.

### BRIEF DESCRIPTION OF THE DRAWINGS

FIG. 1 illustrates a top, side, and perspective view of the present invention with a torchiere lamp.

FIG. 2 illustrates the same embodiment without reference to the lamp.

FIG. 3 shows a top, side, and perspective view of the two pieces in interlocked position.

FIG. 4 illustrates a top, side, and perspective view with a different interlocking shape and variety in contour line.

FIG. 5 shows a cross section of the apparatus and a detailed view of the grommet as it fits into the table sections.

FIG. 6 shows a variation of the invention with a single piece 22 in front and perspective view in its open position.

FIG. 7 shows the same embodiment in the closed position.

FIG. 8 illustrates another embodiment without the use of a grommet.

FIG. 9 illustrates an alternative method for interlocking the apparatus.

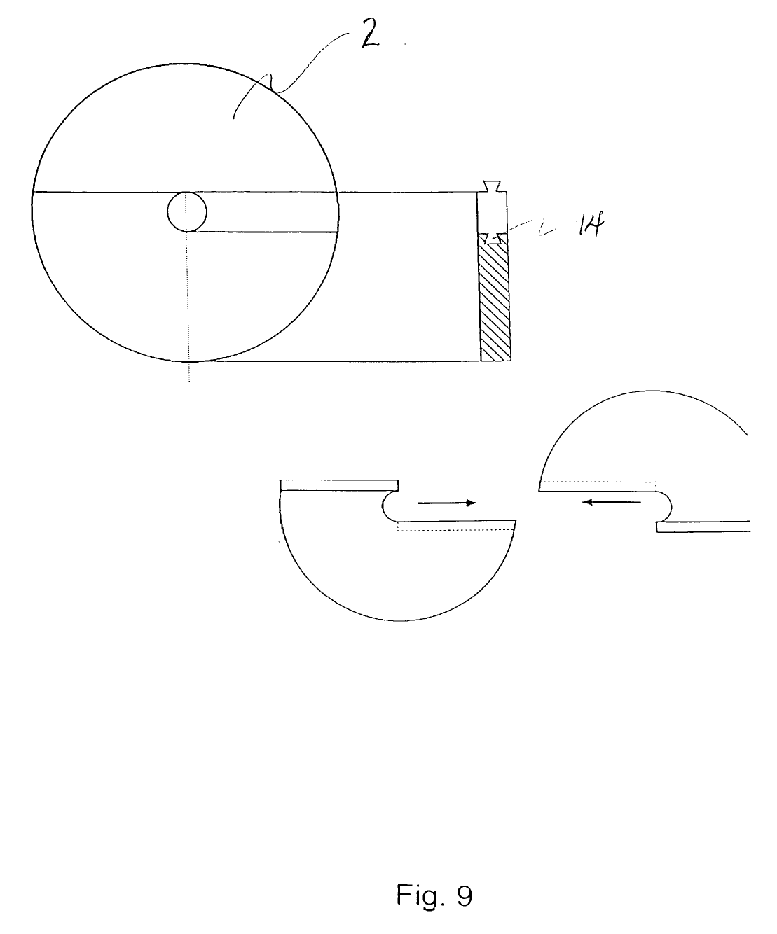

### DETAILED DESCRIPTION OF THE INVENTION

The invention relates to a table surface for attachment to a rigid support characterized by an aperture which receives the rigid support and which is substantially supported by friction between the sides of the aperture and the support. The table surface is not limited to any particular shape or size. For example, the table surface can be selected from a large variety of shapes including, for example, round or circular, elliptical, oval, square, rectangular, triangular, polygonal, or other symmetrical or asymmetrical shape. The size of the surface can vary widely as well and will generally depend upon the size of the support and the desired size of the surface. For example, in some embodiments it may be desirable to have a small table surface (e.g., between about 3 and 10, such as about 6 inches, in diameter or length). In other embodiments, mid-sized table surfaces may be desirable (e.g., between about 10 and 24 inches in diameter or length). In yet other embodiments, table surfaces may be made (e.g., greater than about 24 inches in diameter). For example, where the support is a beach umbrella, the size of the table surface can be less than about 10 inches in length or diameter. Where the support is a floor lamp or torchiere, the table surface can be at least about 10 inches in length or diameter. Excellent stability has been achieved with an approximately 13 inch table surface fitted to frictionally attach to an about 1-1.5 inch diameter support (typical of torchiere lamps).

Further, the width of the table surface is also not critical. The width of the table surface is desirable sufficient to provide substantial frictional contact with the support, thereby preventing slippage. Further, the width should be sufficient to provide stability when the table surface is supporting heavy items at its edge. The minimum width of a table surface will, in general, depend upon the rigidity of the material used its manufacture and the friction that results with the support. Excellent results have been achieved with plaster fitted with a grommet, standard ¾″ plywood fitted with a rubber gasket, and EVA foam of about 1.5 inch thick.

The table surface can, indeed, be made of a large variety of materials. For example, the table surface can be made of wood, e.g., furniture grade woods, butcher block or plywood, such as standard ½ or ¾ inch plywood. Other rigid materials common in preparing furniture can also be used, such as ceramic, stone, metal, glass, medium density fiberboard (MDF), etc. However, the table surface is preferably made from a rigid foam, resin, or polymeric material. Excellent results have been achieved with EVA foam. Other foam or polymeric materials that can be used include, without limitation, rubber, silicone, neoprene, polypropylene, acrylic, ceramic, glass, polycarbonate, nylon, cast nylon, fiberglass, garolite, hypalon, butyl, viton, santoprene, polyurethane, polyurethane foams, polystyrene, polystyrene foams, polymethyl methacrylamide foams, ethylene vinyl acetate (EVA), ethylene propylene rubbers and elastomers (EPR, EPM, EPDM), epichlorohydrin (ECH), polyethylene terephthalate (PET), high density polyethylene (HDPE), styrene-block copolymers (SBCs), poly vinyl chloride (PVC), plasticised polyvinyl chloride (PPVC), polyolefin elastomers (POEs), styrene butadiene rubber (SBR), emulsion styrene butadiene rubber (E-SBR), ultra-high molecular weight polyethylene (UHMWPE), unplasticised polyvinyl chloride (UPVC), acrylonitrile butadiene styrene (ABS), styrene acrylonitrile (SAN) co-polymer foams. Combinations of these materials can also be used. For example, wood (e.g., plywood or wood veneer), laminate, ceramic tile, stone, glass, melamine, polymeric coatings or layers, etc. can be attached to one or all surfaces of another material. For example, the wood (e.g., a furniture grade wood veneer) glued to EVA foam results in a beautiful and stable surface. In other embodiments, multiple materials can be attached to one another in a concentric or similar fashion. Thus, a piece of foam, which contains the aperture, can be surrounded by a second material, such as wood or glass. In this embodiment, the foam can function as a grommet, providing improved friction against the support, as compared to a smoother material, such as glass.

In a preferred embodiment, the material is rigid, deformable or flexible foam, such as EVA foam. This material has the advantage of being sufficiently flexible to make installation and removal easy, without the need for tools and hardware. It is also characterized by substantial memory. Thus, even with substantial and/or protracted deformation, the material returns to its original shape.

The table surface can be flat or not. In one embodiment, the surface has one or more lip at the outer perimeter and/or surround in the aperture to contain spilled liquids or display items. Such a lip may be narrow (e.g., less than 1 inch) or it may be wide, resembling a bucket or bowl. The surface can be characterized by one or more indentations or additional holes or apertures to, for example, receive a desired object. For example, indentations the size and shape of a soda can, coffee cup, soda or beer bottle, ashtray, nails, or screws can be desirable, particularly in applications where the support may not be vertical (e.g., a beach umbrella or ladder), and/or where the surface may not be horizontal (e.g., a beach umbrella), and/or where the surface provides little friction with respect to the items that may be placed upon it (e.g., a smooth, hard, molded, plastic, such as a polyethylene terephthalate (PET)). It has been found, however, that EVA foam provides sufficient surface friction to avoid the need to introduce such indentations.

The selection of the support is also not critical. The support can be one or more poles, such as can be found with indoor or outdoor household or other common items. Suitable supports include lamps, such as floor lamps and torchieres; poles, such as beach or table umbrella pole; balusters; balustrades; railings; handrails; rods; bedposts; columns; ladders; mailboxes; microphone stands; pipes; parking meters; telephone poles, etc. Thus, the diameter of the support and shape of the support can vary widely. Typical torchiere lamps are characterized by a pole having a 1 inch, 1 1/4 inch or 1 1/2 inch diameter, for example. Beach umbrella poles are generally narrower. Table umbrellas are generally wider. Indeed, mail boxes, parking meters and telephone poles are very wide. Preferred supports are at least 1 in. in diameter, preferably between about 1 in and 2 in. in diameter. The supports can be circular, round, elliptical, square, or any other shape. They can be rigid, as is typical with a floor lamp, or other metal or wooden pole, or semi rigid, as can be obtained with a goose neck lamp. Further, a table surface that is supported by more than one support or pole can be easily envisioned. Thus, the table surface can surround two or more supports. This embodiment can be taken advantage of with balusters, ladders, or display racks, for example.

The invention functions by frictional contact between the apparatus and the support. Typically, the apparatus or table surface is characterized by an aperture which is shaped and sized to receive the support. Generally, optimal frictional contact will be achieved where the aperture has the same shape as the support. Common supports will be circular or round. As such, the preferred table surface will have a substantially circular or round aperture and the support will be substantially circular or round. However, this is not required. For example if the support is fluted, the aperture may still be designed to be round, providing ease of manufacture and installation and sufficient frictional contact. It is also possible to achieve sufficient friction between a square aperture and round support and vice versa.

Excellent frictional contact can be achieved if the aperture is substantially the same as or slightly smaller than the support. This is particularly true where the material surrounding the aperture (whether it be the material of the table surface itself or a grommet or liner, as will be described in more detail below) is deformable high friction material, such as EVA foam. Thus, in one embodiment, the aperture is about 5% smaller in diameter than the targeted or intended support thereby permitting compression upon installation and improved frictional support.

The aperture can be centrally located in the table surface or located off center. Indeed, it is possible that the aperture be at the edge of the table surface.

The aperture can be, optionally, lined with a grommet, whereby the grommet provides the frictional contact. This can be particularly advantageous where the desired table surface does not or is unlikely to provide substantial frictional contact. Thus, where the table surface is glass, or a smooth, hard plastic, for example, a grommet can be used to provide the desired frictional support. EVA foam and rubber are preferred grommet materials. The grommet can be narrow, such as ¼ in thick, or wide, such as 1 in. thick or more. The grommet may be characterized by a slit to facilitate its attachment to the table surface and or support or shaft. Further, the grommet can be glued, screwed, or frictionally attached to the table surface.

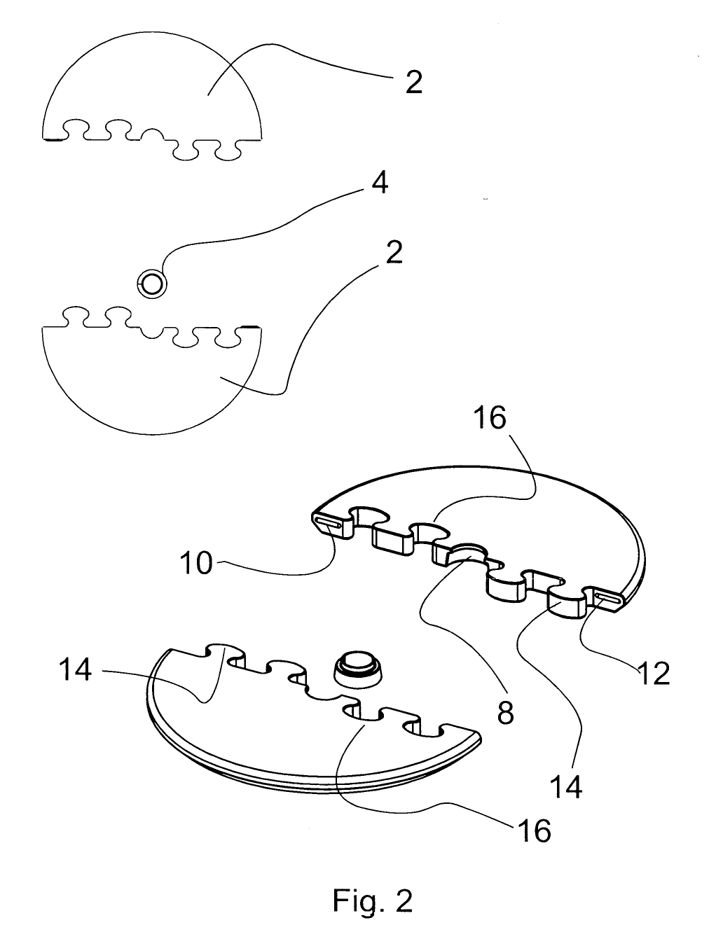

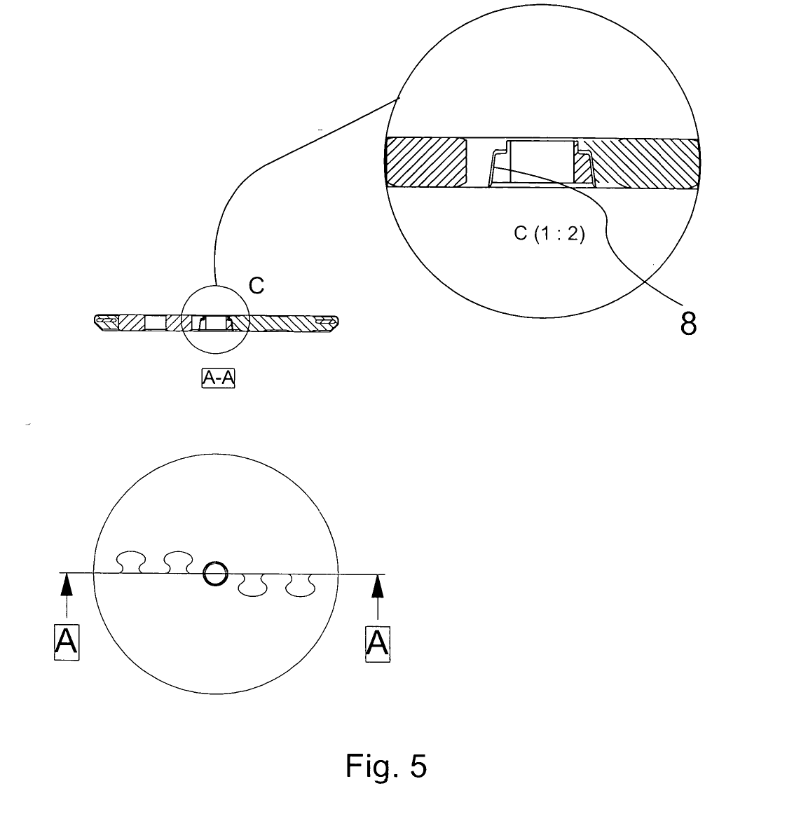

The grommet and/or aperture can be tapered, or not. Thus, the diameter/shape of the aperture at one surface can be the same or different from the diameter/shape at another surface of the table. Where the aperture or grommet are tapered, the downward force on the table surface (or caused by the table surface itself) can cause compression and a tightening against the support or shaft, preventing slippage. FIGS. 2 and 5 illustrate this aspect of the invention with a grommet 4.

However, while a grommet can be used, an excellent table surface can be made without the grommet. As such, a preferred table surface of the invention does not possess a grommet.

It may be desirable, although it is unnecessary, to employ additional hardware and clamps to support the table surface to the support. As such, it should not be construed as an admission that embodiments employing additional hardware and clamping mechanisms are excluded from the present invention. Nonetheless, it was an unexpected discovery that a table surface with superior stability could be manufactured which is solely frictionally supported in the absence of additional hardware or clamping devices. That is, the friction between the material surrounding the aperture (i.e., the sides or wall of the aperture), comprising the material of the grommet or table surface, as the case may be, is sufficient to stably support the table surface.

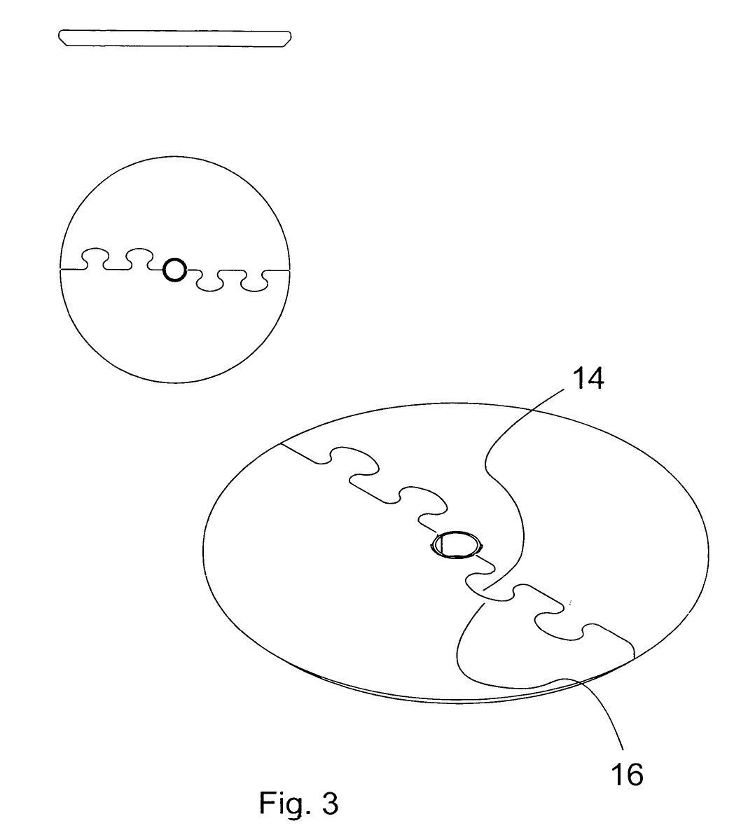

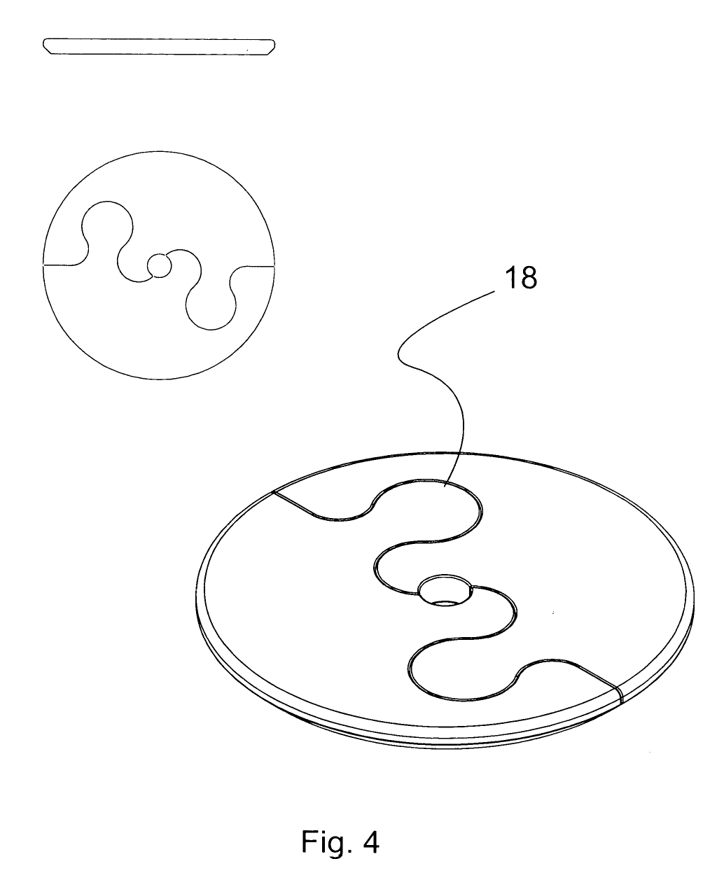

As discussed above, the table surface can be made of one, two, three, or more pieces of the same or different materials. Preferably, the table surface comprises two or three interlocking pieces. This embodiment has the advantage of installation without taking apart or moving the support structure. Thus, in the case of a floor lamp, the bottom of the lamp need not be removed to install the table surface. The pieces are preferably interlocking to avoid the need for additional hardware to install the table surface. Referring to FIG. 3, the pieces 2 can be fitted together around the central shaft of a torchiere, or support, 6 with dovetails 14 fitting into inverse dovetails 16, for example. The sizes and forms of the dovetails are not critical. Thus, a single dovetail per side (FIG. 4) or two dovetails per side (FIG. 3) or more can be used. Further lateral or vertical dovetails can be used.

The pieces can be the same (identical) or different in shape. Employing identical pieces simplifies manufacture substantially.

In yet another embodiment, the table surface is a single piece. In this embodiment, the support can slide through the aperture. This can be convenient in an embodiment designed for use with a beach umbrella. Alternatively, the single piece can have a slit through a side of the table surface to the aperture to receive the support. In this embodiment, the slit can be a simple line or it can be interlocking, like above.

Where the table surface comprises interlocking members or is characterized by a slit to receive the support, the walls of the slits or the interlocking surface may be, advantageously, frictional as well. This can be achieved by the selection of the table surface material (as discussed above), with EVA foam providing a superior frictional surface. Alternatively, the surface can be coated or lined with a frictional material, such as sand. In another embodiment, the interlocking surface is characterized by a dentate to facilitate alignment of the top surfaces of the pieces.

The table surfaces of the invention are preferably characterized by strength and stability. For example, in a preferred embodiment, the table surface can support a weight of at least 30 ounces for at least two weeks without substantial deformation.

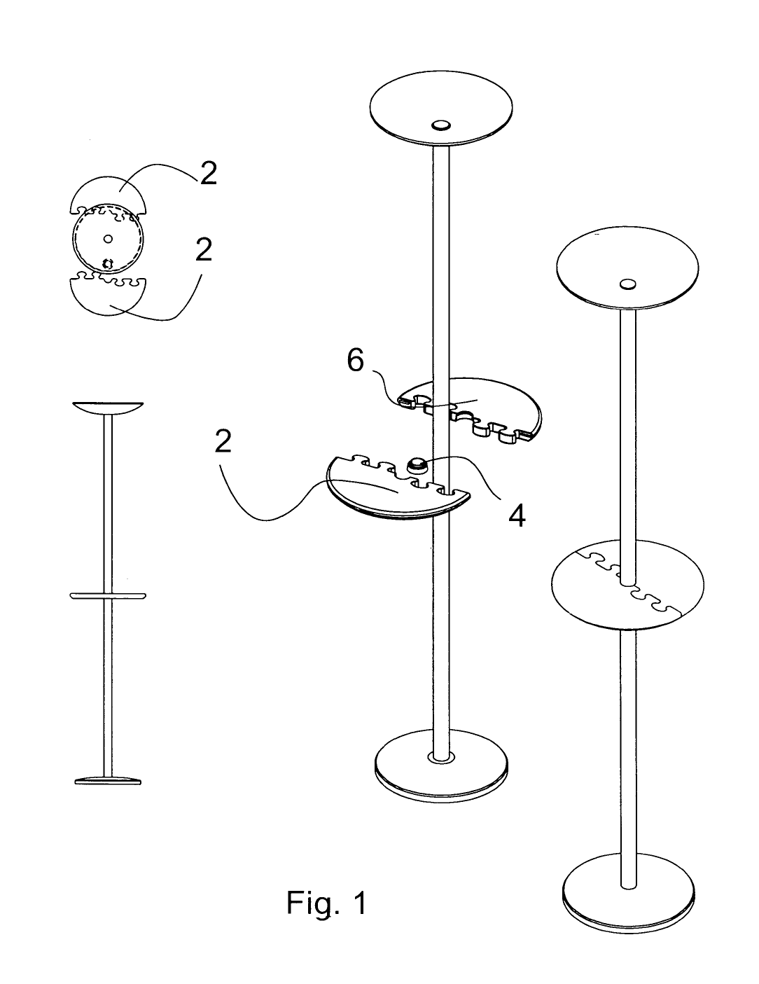

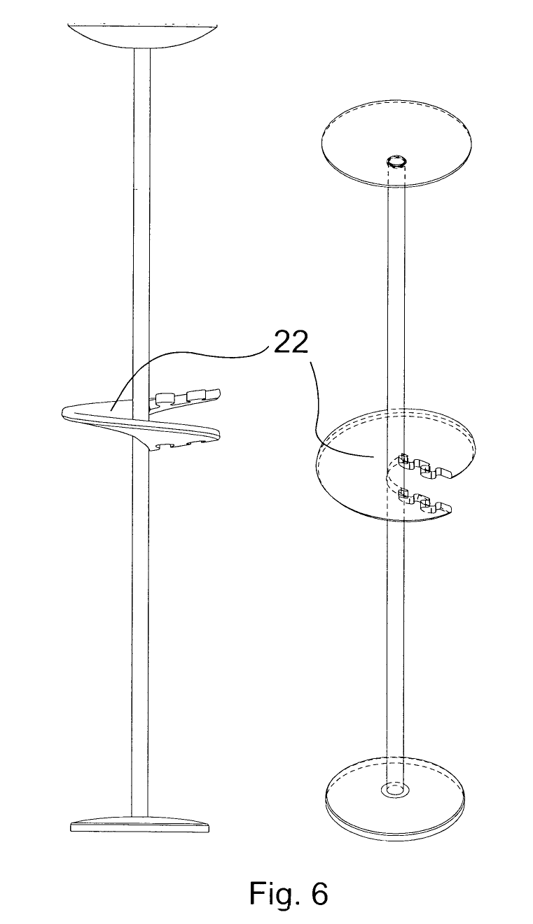

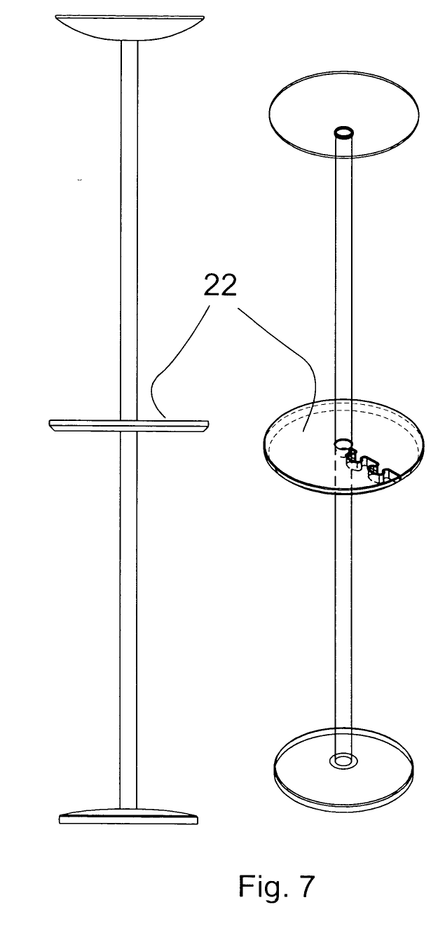

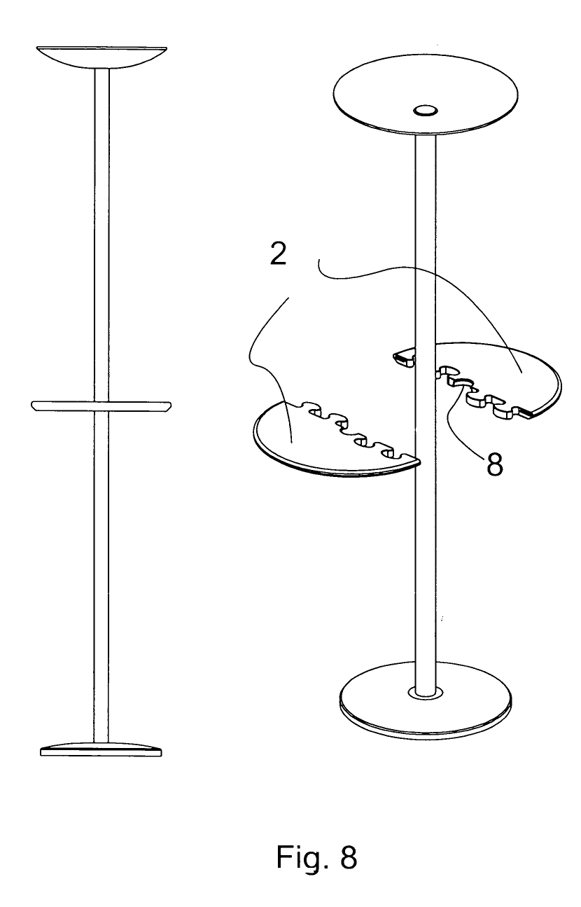

Referring to the specific figures provided herein, FIG. 1 illustrates a top, side, and perspective view of the present invention. Shaft 6 of the torchiere lamp 1 supports two interlocking pieces 2 which, when combined, form an aperture 3. The aperture is lined by an optional grommet 4. FIG. 2 illustrates the same embodiment without reference to the lamp. FIG. 2 also illustrates the interlocking dovetails (or dentates) 14 and the inverse dovetail 16; an optionally tapered hole 8 for a grommet is also illustrated; as is an optional dentate for 10 and receptacle 12 for aligning the top surface. FIG. 3 shows a top, side and perspective view of the two pieces in interlocked position. FIG. 4 illustrates a top, side and perspective view with a different interlocking shape and variety in contour line. FIG. 5 shows a cross section of the apparatus and a detailed view of the grommet as it fits into the table sections. FIG. 6 shows a variation of the invention with a single piece 22 in front and perspective view in its open position; while FIG. 7 shows the same embodiment in the closed position. FIG. 8 illustrates another embodiment without the use of a grommet.

While this invention has been particularly shown and described with references to preferred embodiments thereof, it will be understood by those skilled in the art that various changes in form and details may be made therein without departing from the scope of the invention encompassed by the appended claims.

1. A table surface for attachment to a rigid support characterized by an aperture which receives the rigid support and which is substantially supported by friction between the sides of the aperture and the rigid support.

2. The table surface according to claim 1 wherein the cross section shape of the rigid support and aperture are substantially circular.

3. The table surface according to claim 2 wherein the rigid support and aperture are at least about ½ in. in diameter.

4. The table surface according to claim 3 wherein the diameter of the rigid support and aperture is between about 1 and about 2 in.

5. The table surface according to claim 4 the diameter of the aperture is about 5% less than the diameter of the rigid support.

6. The table surface according to claim 1 wherein the table surface comprises two or more interlocking pieces.

7. The table surface according to claim 6 wherein the table surface consists of two or three interlocking pieces.

8. The table surface according to claim 7 wherein the interlocking pieces are substantially identical.

9. The table surface according to claim 1 wherein the aperture is not covered with a grommet.

10. The table surface according to claim 9 wherein the table surface comprises a rigid, deformable foam.

11. The table surface according to claim 10 wherein the rigid, deformable foam is an EVA foam.

12. The table surface according to claim 11 wherein the upper surface of the EVA foam comprises a veneer.

13. The table surface according to claim 12 wherein the veneer is a wood veneer.

14. The table surface according to claim 1 wherein the aperture is covered with a grommet.

15. The table surface according to claim 14 wherein the grommet comprises a rigid, deformable foam or rubber.

16. The table surface according to claim 15 wherein the rigid, deformable foam is an EVA foam.

17. The table surface according to claim 16 wherein the table surface comprises wood.

18. The table surface according to claim 17 wherein the table surface comprises plywood.

19. The table surface according to claim 1 consists of two interlocking pieces and is solely supported by friction between the sides of the aperture and the rigid support.

20. A table surface according to claim 1 wherein the table surface can support a weight of at least 30 ounces for at least two weeks without substantial deformation.

21. A table surface for attachment to a rigid support characterized by an aperture which receives the rigid support, wherein said table surface consists of two interlocking pieces manufactured of rigid deformable foam and is solely supported by friction between the sides of the aperture and the rigid support.
